(19) United States
(12) Patent Application Publication
(10) Pub. No.: US 2009/0048865 A1
(43) Pub. Date: Feb. 19, 2009

(54) Patient Tracking Systems and Methods

(76) Inventor: Earl Edward Breazeale, JR., Louisville, TN (US)

Correspondence Address: FISH & RICHARDSON P.C., PO BOX 1022, MINNEAPOLIS, MN, 55440-1022, US

(21) Appl. No.: 11/840,010

(22) Filed: Aug. 16, 2007

(51) Int. Cl. G06Q 50/00

(52) U.S. Cl. 705/2

(57) ABSTRACT

A computer-implemented method is disclosed, The method can include relating a transponder with a healthcare patient, identifying one or more locations of the patient using the transponder, and associating the one or more locations with one or more time values, and associating the one or more locations or time values with one or more billable events in the patient's care.

### TECHNICAL FIELD

Various implementations in this document relate generally to tracking status of patients and other items in a healthcare setting, such as for use in billing and auditing operations.

### BACKGROUND

Increasing costs for healthcare are turning into a serious drain on our economy. They directly affect many people who cannot afford needed medical care, and they indirectly affect those who can afford healthcare but need to subsidize the system for others. Surgical care is one of the most expensive areas for many patients—with high costs for specialists, assistants, facilities, and goods such as medical devices. Ongoing care—such as physical and occupational therapy—is another area in which costs are often high for many patients, with repeat visits required over many weeks, months, or even years.

Billing errors and fraud are also potential problems in the healthcare field. Healthcare providers perform many different procedures that need to be billed out, from providing aspirin or an IV to performing a full scale surgery, and they are often in a poor position to track and record such procedures (e.g., because they are in the patient's run busy performing the procedure rather than at a computer terminal recording it). Providers may also tend to multiple patients before being able to enter billing-related information, and may be interrupted by other small or large emergencies during their work.

Patients may be unable to detect or correct billing errors. They may not be able to keep track of every medication they were given, or every test or other procedure that was performed on them. They may also not understand how items are billed in the medical world. Thus, when they get their bill, they may not know what is right and what is wrong. Also, medical bills can be hard to decipher even for short hospital stays that do not involve much testing. In addition, many of the costs in healthcare occur outside the patient's view or when the patient is not attentive. As a result, errors in a bill, whether unintentional or intentional, may go unnoticed by the patient and by the healthcare providers.

### SUMMARY

This document describes various techniques and systems for tracking healthcare patients and other objects. In one example, the tracking may enable creating or verifying billing information associated with patients. Such billing information may be time-based information, such as “in” and “out” times for caregivers by which those caregivers bill their services. The measured times can be correlated to time-based information relating to the patient, e.g., the time at which the patient entered an operating room, a physical therapy room, or a recovery room. Such information may be used to generate bills for the patient (e.g., when a patient or caregiver's location reflects a triggering event for billing purposes) or can be compared against other billing information (e.g., obtained from a patient chart or caregiver time entries) to ensure that all of the available time information is as accurate as is practical.

Such techniques may provide for tracking of accurate time for certain procedures, as opposed to the use of relatively inaccurate estimates of time. For example, in the area of anesthesiology, actual entry of the patient into an operating suite or exit of the patient from a pre-op area may be used to compute the time an anesthesiologist spends with the patient, rather than provider-estimated times. In addition, different triggering events may be used with such an approach, such as pre-op exit time rather than a time that an anesthesiologist provides a calming mediation, because the time data may be captured even where the caregiver is unable to capture it. This approach may eliminate problems, such as when delays is finishing one procedure create delays in starting other procedures; where the start point for billing time is set too early in the process (e.g., at the provision of calming medication), billing may continue to occur for multiple patients during the delay period even though they are not being addressed by the anesthesiologist. As a result, the techniques described here may provide accurate time assessments for care given to a patient, and may thus better match the effort expanded on behalf of the patient with the amount paid by the patient.

In some implementations, a computer-implemented method is disclosed. The method comprises relating a transponder with a healthcare patient; identifying one or more locations of the patient using the transponder, and associating the one or more locations with one or more time values; and associating the one or more locations or time values with one or more billable events in the patient's care. The transponder can be mounted to a piece of medical equipment attached to the patient, to the patient, or, for example, to an IV device. The transponder can include an RFID chip

In certain aspects, the billable events include a stop time for anesthesia billing. The one of more locations can also include entry of a patient into a recovery room, and the method may further comprise computing a billable amount using a time of exit from a pre-operative holding area. The billable events can also include a start time for a procedure performed on the patient, and arrival and departure from a room in a facility. The method may further include mediating challenges to billing amounts for the billable events. In addition an elapsed time can be computed using the one or more time values, and a fee based on the elapsed time can also be computed. In addition, the billable events may be associated with a hospital billing code, and the method may also include obtaining the one or more locations from a facility scheduling program.

In another implementation, a computer-implemented system is disclosed. The system includes memory storing time-location information for a plurality of patients in a healthcare system, the time-location information correlating a physical location of a patient with a time the patient was at the physical location, a time-location server to identify one or more billing events for a patient base on the time-location information, and a billing server to generate a billing level for the patient based on the one or more identified billing events. The time-location server can associate a location with stored procedure data on a procedure performed on the patient. Also, the time-location server can filter time-location information based on a time of a procedure performed on the patient.

In some aspects, the billing server uses the one or more identified billing events to confirm accuracy of billing information entered by one or more caregivers. Also, the billing level can be associated with a billing code.

In yet another implementation, a computer-implemented system is disclosed. The system comprises memory storing time-location information for a plurality of patients in a healthcare system, the time-location information correlating a physical location of a patient with a time the patient was at the physical location, and means for associating locations of patients with procedures performed on the patients to generate time information for patient billing.

The details of one or more implementations are set forth in the accompanying drawings and the description below. Other features, objects, and advantages will be apparent from the description and drawings, and from the claims.

### DESCRIPTION OF DRAWINGS

FIG. 1 is a conceptual diagram showing tracking of a patient as part of a surgical procedure.

FIG. 2 is a schematic diagram showing a system for tracking patient activity.

FIG. 3 is a schematic diagram showing computing structures in a healthcare billing system.

FIG. 4 is a flow chart showing actions associating patient activity with billing activity.

FIG. 5 is a swim lane diagram showing actions for coordinating patient tracking with billing.

FIG. 6 is a conceptual diagram showing example database elements for a healthcare billing system.

FIG. 7 is a block diagram of computing devices that can be used to implement the systems and methods described herein.

Like reference symbols in the various drawings indicate like elements.

### DETAILED DESCRIPTION

The systems and techniques described in this document relate generally to tracking patient locations in a hospital or other healthcare facility and associating those locations with time. Such time-location data may then be provided to, and/or coordinated with, a billing system. For example, a transponder such as an RFID tag may be physically associated with a patient (e.g., on a wrist band) and its code may be electronically associated with the patient's records in a computer system. The patient's location may be tracked as the patient passes tracking devices (e.g., RFID sensors) in a hospital to identify times at which the patient was in the vicinity of such tracking devices. Certain tracking events may be kept by the system (e.g., entry of an operating room in which the patient had surgery) and others may be discarded (e.g., passing the doors of other patient rooms or other operating rooms as the patient moves down a hallway). The relevant tracked time-location data may then be used to determine how long the patient spent during certain portions of their stay, and that information may be used to produce accurate billing information for the patient.

As one example, certain caregivers bill (or can bill) patients according to time they spend treating the patient. The tracking and billing coordination techniques described here may be used to provide an accurate and automatic view of how long those caregivers actually spend performing the work. Such data may be used to produce bills for a patient's care, thereby eliminating an administrative timekeeping burden from such caregivers. Or such tracking information may be used as a check on manually entered time or other billing entries—e.g., as a loose check simply to confirm that a particular procedure actually occurred, or as a more precise check to make sure that manual entries were recorded accurately and that accidental overbilling or underbilling did not occur.

One such exemplary area for time tracking is anesthesiology. There, billing generally occurs according to the AMA's Current Procedural Terminology (CPT) surgery codes that are then associated with American Society of Anesthesiologists (ASA) or Medicare base unit values. Such based units may be used for non-time based billing to assign a billable amount for certain classes of work. In particular, each base unit may be assigned a value, and the cost for a particular procedure may be computed by multiplying the value by the number of base units identified for the procedure. For example, a basic procedure may be identified as a “class 1” procedure for which four base units may be assigned. The rate for the procedure may be computed easily, and pricing may be negotiated easily for base units without having to also re-determine base units. Anesthesiology services may also be billed based on time, and additional services could be billed on time if improved time-tracking mechanisms were available. In addition, a globally acceptable anesthesia start time may be formed or adjusted from what is presently employed—as one example, use of pre-op exit time for a patient could be used and may provide a more accurate indication of anesthesiologist activity that earlier times.

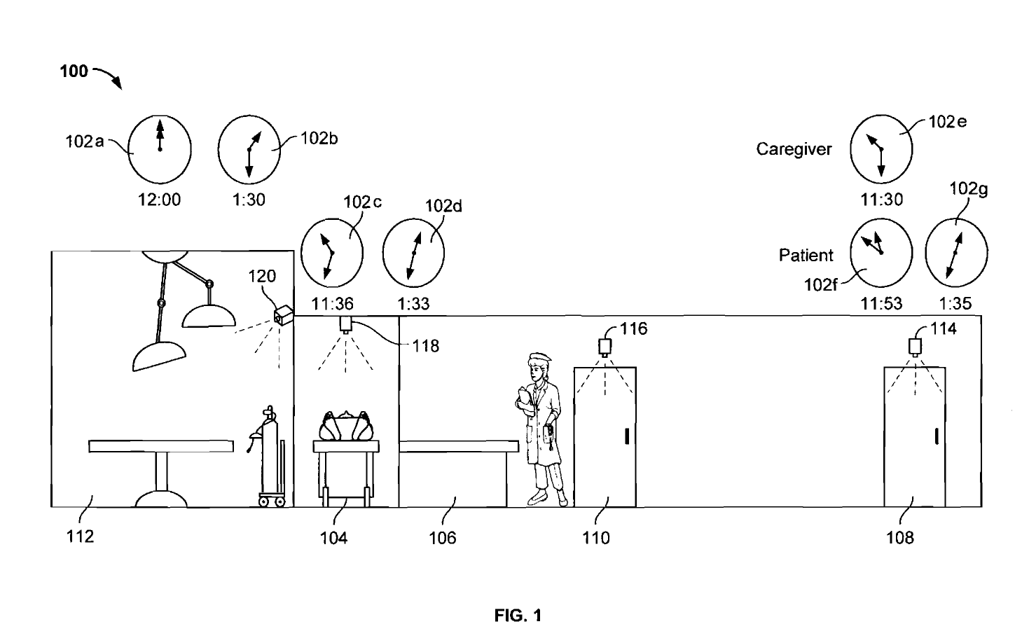

FIG. 1 is a conceptual diagram showing tracking of a patient as part of a surgical procedure. The diagram shows conceptually a healthcare facility 100 having two patient rooms 108, 110, and an operating room 112 that is part of an operating suite. Various proximity sensors 114-120 are positioned throughout the facility 100 to track movement of objects in the facility. Such systems may be commonly used to track various objects in a facility for various purposes, such as to allow facility managers to track the location of equipment located in the facility. In the implementation described here, the data collected by the tracking system may be accessed and used for other purposes such as for billing.

Various representations of clocks in the figure show the progress of a patient around the time of a surgical procedure. Each clock represents a recognition event by one of the sensors 114-120, caused by a patient-associated transponder moving within range of a particular sensor. The transponder may be located, for example, in a patient ID bracelet, on an IV pole, or in another location attached to the patient or to a piece of equipment associated with the patient. Objects other than the patient may also be tracked by the system. For example, caregivers may be provided with identification badges or other objects containing a transponder that may be recognized by the system. As a result, location and time information for a patient may be correlated with location and time information for one or more caregivers, to provide additional information for billing purposes, and or to provide confirmatory information for billing purposes.

Clock 102e represents a recognition of a caregiver by sensor 114. The transponder associated with the caregiver may, in response to a signal from sensor 114, transmit a digital message, such as an identification number, that a computer system may associate with the caregiver. The identity of the caregiver, the location of the sensor 114, and the time of the recognition event may all be stored by the tracking system for later access by various other systems. In this example, the caregiver may be an anesthesiologist who has entered a room 108 to provide a patient with a calming medicine before a surgical procedure. Another triggering event may be sensed when the caregiver leaves the room 108, and data for that event may also be stored by the system. As explained in more detail below, certain events may be considered triggering events that will be used by other parts of the system (e.g., those needed for billing), while other events may be ignored by the system (e.g., those when a patient happens to randomly pass by a sensor).

Clock 102f indicates an event of a patient passing through the door to room 108. The patient may then be rolled down a hallway, past nursing station 106, and into a hallway of a surgical suite, where the patient's presence is recognized by sensor 118. In moving from room 108 to the surgical suite, the patient may pass room 110, and sensor 116. Such movement may create a triggering event for the system. However, the event may be filtered by the system and not recorded. That is because the passage of a patient past the room of another patient may be considered an event that is not useful to any part of the system, so that storage of such information would be unnecessary.

The filtering may occur, for example, by defining rules for certain objects (e.g., patients, caregivers, or equipment) with respect to the way triggering events for those objects are to be treated. For example, patients may be one class of objects and may be associated with a particular patient room. Rules may be defined, for example, so that when a triggering event occurs for a patient object with respect to a certain class of locations, such as patient rooms, only triggering events related to the patient room associated with the particular patient are recorded. Other such rules may control the handling of other sensed events.

Clock 102c shows the time of the patient entering the operating room suite, and clock 102a shows the time of the patient entering operating room 112, as determined by sensor 120. Clock 102b shows the time of the patient exiting operating room 112, while clock 102d shows the time of the patient passing sensor 118 while exiting the operating suite. Clock 102g shows the time of the patient reentering patient room 108. In an ordinary example, however, the patient may be moved from operating room 112 to a recovery room and tracked by a sensor there.

By this process, the system has stored a number of time-location pairs that may be associated with a particular patient. The time-location pairs may generally be unassociated with any actions, in that they are simply a time at which a particular sensor was triggered by a transponder associated with an object such as a patient or caregiver, and a corresponding location of the sensor.

However, certain actions regarding a patient may be inferred by combining the time-location information with certain contextual information. Such contextual information may include information about procedures for which a patient was scheduled, or that were performed on a patient. There, time-location information for the patient relating to particular areas the patient would be expected to pass during certain portions of the procedure, can be used to infer that the patient had certain portions of a procedure performed at certain times. For example, taking the difference in readings between clock 102a and clock 102b may permit the system to determine that the patient's operation, which was scheduled around the time of the readings for clock 102a and clock 102b, lasted 1.5 hours. If the range of sensor 120 is too long spatially to differentiate between an entrance to operating room 112 and an exit, because the patient is sensed throughout the time they spend in the operating room 112, the signal may be sampled and the start and end times for the presence of the signal may be used to measure the patient's stay, or a sensor farther away from a location in which the patient loiters may be used, such as sensor 118.

As another example, and as explained in more detail above and below, a caregiver such as an anesthesiologist may be billed to a patient based on the amount of time the anesthesiologist spends with the patient. The billing clock in such a situation may begin with the provision of a first medication to the patient or another event, and may end with the patient's entry into a recovery room. In such a situation, when a billing system is preparing charges related to a procedure, or is verifying charges for the procedure, it may look to records related to the patient to identify the particular procedure.

Such an inquiry may identify the time of the procedure, such as by querying an operating room scheduling system. The billing system may then query a tracking system to identify all triggering events for an anesthesiologist that corresponds to the procedure. The system may filter the returned data to identify only relevant triggering requests, such as entry by the caregiver into the patient's room during a timeframe before the procedure, such as to begin the administration of medication. The system may likewise query a tracking system for triggering of actions related to the patient, such as entry by the patient into a recovery room or into a hallway associated with a recovery suite. The difference between the identified time associated with the caregiver and the identified time associated with the patient may be the billing time for the anesthesiologist.

Such information may be used in a variety of ways. For example, the information may be used to generate a charge for the patient in a first instance, where the accuracy of the system is sufficiently good. Alternatively, a portion of the information may be used to generate a charge for the patient. For example, an anesthesiologist may record a time to start a billing, while the end of the billing period may be triggered by the sensing of the patient's return to a recovery room. The information gathered by the system may also be used as a check on other information, but not necessarily used to produce the information that drives a billing decision. For example, caregivers may record times at which certain events take place in a traditional manner, and the location data may be used by an audit component of a system to verify that no errors have been made in such recordings. For example, the system may be used to ensure that, where a charge occurs, there actually was a procedure related to that charge. Or, a system may look more closely and compare events sensed by the system with times recorded by caregivers to ensure that the times are within a certain level of difference, such as less than five minutes of difference.

The additional contextual information that accompanies a time-location reading for a patient may also be a time-location reading for another object. For example, if a transponder associated with a patient and a transponder associated with a particular caregiver create simultaneous or near simultaneous triggering of a sensor, the activity being performed on the patient may be inferred. For example, if the caregiver is a surgical nurse, then it may be inferred that the patient is heading to/from surgery.

In addition, the time-location information for caregivers may be analyzed to ensure that their billing of time is consistent with certain guidelines. For example, the Centers for Medicare & Medicaid Services (CMS) may have limits on the number of patients that a caregiver may serve and bill simultaneously (e.g., limiting anesthesiologists to four overlapping patients at one time) and may use such time-location information to check compliance with such limits. Where raw time-location data is stored for a number of patients and a number of caregivers, various forms of post hoc analysis may be performed, with new queries run on the data to produce new analyses.

Such analyses may involve analyzing the times for which a patient was receiving active care during a stay at a facility, e.g., by correlating billed events with time-location data for the patient and for various caregivers. This analysis may permit a facility to provide a patient with a report indicating the amount of care they received, so that the patient may better see what he or she received for his or her money. In addition, such information may be tracked for caregivers, to better manage and train caregivers so as to maximize the care they provide and the efficiency of the care they provide. In addition, certain of the time during a patient's stay may be identified as time that there should be no care (i.e., the patient is resting) and other time may be identified as time that there should be care. The actual treatment of the patient may be compared to such a profile to gain a better understanding of whether the patient's treatment was adequate or could be improved. Moreover, similar data may be accumulated across multiple caregivers in a facility and may be used for benchmarking. For example, certain actions relating to orthopaedic surgery may be analyzed and average to provide an indication of the level of care and the efficiency of the care a facility provides. Such analysis may permit the facility to isolate problems in its processes and make them more efficient and/or may permit insurance companies, consumers, or others who are interested in comparing the quality and efficiency of care between facilities to do so.

The techniques here may also be used in a part of a pay for performance type of program. Such a program generally attempts to track the time that a physician or physician group requires to perform a procedure, and the number of complications or other negative events associated with the procedure. The program attempts to award physicians or physician groups that perform quickly or efficiently, while still providing high quality care. More accurate tracking of physician time and other time associated with a patient may permit more accurate tracking of performance in such a pay for performance program.

Certain approaches may be used to help maintain patient privacy in a system like that described above. For example, a tracking system may simply be provided with transponder ID's for tracking of patients, but may not be provided with any information by which to associate a particular patient with a particular transponder. In addition, a tracking system may be controlled to authenticate requesters for tracking information, and may only give access to trusted requesters, or may provide access on an as-needed basis. For example, a requester may provide information to a tracking system regarding a particular procedure, and the tracking system may then obtain information about the procedure from another portion of a system to determine when the procedure occurred, and to thereby limit the provision of tracking data about a patient to a particular time period around the time of the procedure, and may provide information only for locations of the patient that might be relevant to the particular procedure. Such filtering of time-location information may also occur in other parts of the system and for purposes other than patient privacy.

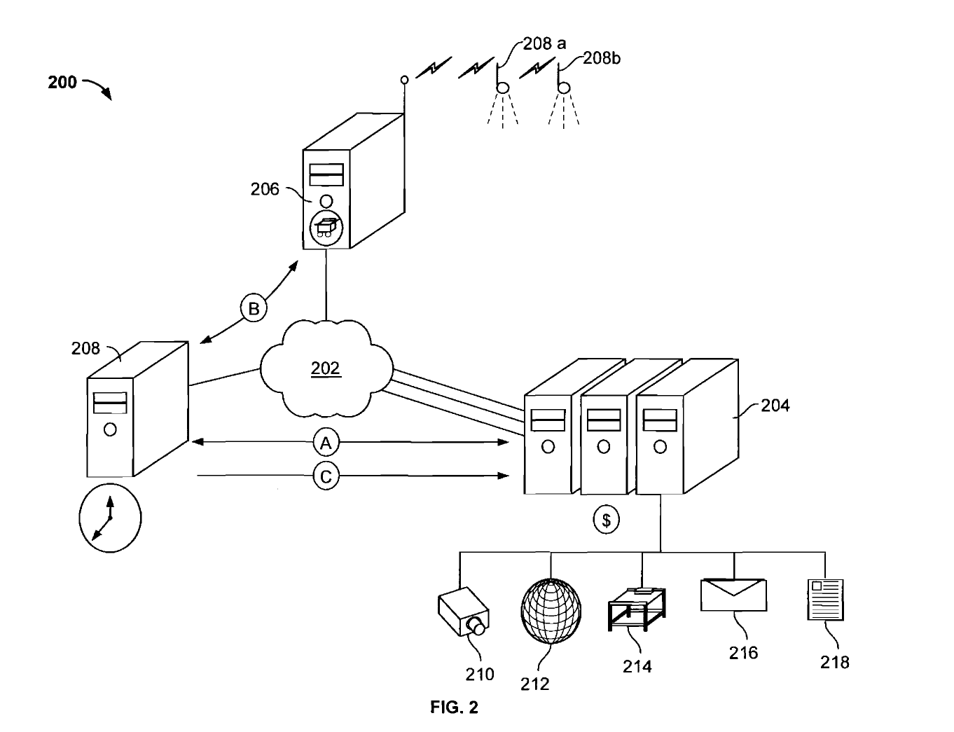

FIG. 2 is a schematic diagram showing a system 200 for tracking patient activity. In general, the system 200 provides a number of structural components for correlating time and location data for objects in a health care facility, with a billing system associated with the facility. The system 200 generally includes a number of servers connected by a network 202, such as a local area network or a wide area network. The servers include a group of billing servers 204 running a patient billing system, a location server 206 that tracks locations of objects in a facility or facilities, and a patient tracking server 208. Though expressed and shown as separate servers, the particular servers may be combined into one or more common servers, or actions provided by a particular server may be shifted to another server or other servers.

In certain implementations, the system 200 may be implemented in a modular manner so as to permit existing systems to be integrated, to provide the functionality described in this document. For example, billing servers 204 may run and operate standard billing systems from a variety of vendors, and may be communicated with through an application programming interface (API) in familiar manners. Likewise, the location server 206 may be able to operate software from various vendors for tracking locations of objects, such as objects equipped with RFID tags. Communications with the location server 206 may occur via queries or other form of API. Time-location billing capabilities may then be provided as an add-on feature to such systems, such as part of a plug-in module, or an additional server that monitors the operation of the main servers and receives periodic calls from the main servers and provides information in response.

Billing servers 204 may provide for various functions relating to the operation of a healthcare organization. For example, billing servers 204 may track the admission, treatment, and discharge of patients, along with tracking procedures and other activities related to the patients. In doing so, billing servers 204 may create bills or invoices for payments relating to patients, and may provide the bills, for example to the patients, insurance companies, or the government, as appropriate. For illustrative purposes, billing servers 204 are shown as larger and greater in number than the other components of system 200, to reflect that billing systems in a healthcare organization are generally large and complex. However, the arrangement of the particular components here is not meant to be limiting, and various numbers, arrangements, and types of computers may be used in the system 200.

Various ancillary billing functions may also be provided by the billing servers 204. For example, dispute resolution module 210 may be provided to track disputes over bills or disputes over billing (e.g., when caregivers dispute their payments). Report module 214, pictured as a printer, may produce various reports (electronically or on paper) relating to patient care, billing, financial performance, and other such reports typically generated by a healthcare information system. A bill distribution module 216 may provide for the aggregation of billed items into a bill, whether electronic or on paper, and the distribution of such items to the appropriate payor, such as an insurance company and/or the patient. Bill creation module 218 may generally provide for the assembly of bills which may subsequently be distributed by bill distribution module 216 or by other mechanisms.

Billing servers 204 or other similar systems within system 200 may provide additional functionality. For example, system 200 may be provided with electronic medical record functionality, whereby patient charts and other similar information are stored electronically, and are accessible without a need for paper records. In such an implementation, the portion of system 200 responsible for the electronic medical records may provide information such as information about procedures performed on the patient, to other components in system 200. With respect to tracking procedures performed on a patient, entries in an electronic medical record may be used to establish or verify the timing of certain events in a patient's care. As one example, it may be possible that a certain event, such as a surgical procedure, may not be performed until after a nurse or physician has entered a particular value into a medical record. Thus, if billing for the procedure occurs before such a value is entered, it may be presumed that there is an inaccuracy in the medical record or in the billing records.

Location server 206 generally includes components for receiving signals from sensors 208a, 208b, and for storing information associated with the events that triggered the signals. For example, the location of each sensor 208a, 208b may be registered with location server 206, and identifiers for objects that fall within the spatial range of the sensors may be transmitted to location server 206. For example, an RFID chip may transmit a digital code representative of an identification number for an object to which the RFID chip is attached. That code may be forwarded from the sensors to the location server 206, and the location server 206 may generate a timestamp for the event of the object falling within the range of one of the sensors. From this received and determined information, the location server 206 may provide information about the identity of an object, its location at certain times, and the times when the object was in each particular location. Sensors may themselves timestamp certain occurrences and may also store the occurrences and submit them to a central system using batch processing.

Patient tracking server 208 may communicate with location server 206 and billing servers 204 to provide for tracking of patients for the purpose of producing or verifying billed amounts for patient care. Although shown as a separate server, patient tracking server 208 may be provided as part of location server 206 or billing servers 204 (and all of the components may be provided on one single server or group of servers). For example, the functionality of patient tracking server 208 may be incorporated as a plug-in or other similar module that may be added to a pre-existing patient billing system. In a similar manner, such functionality may be incorporated directly into a base patient billing system.

Lettered arrows in FIG. 2 provide an example of communications that may occur during a process for establishing or verifying billing for a particular patient. Arrow A shows initial communications between billing servers 204 and patient tracking server 208. For example, billing servers 204 may be involved in a patient billing cycle, such as a monthly billing cycle.

In preparing bills for the monthly billing cycle, portions of the patient billing system may recognize the presence of a procedure performed on the patient (e.g., by the occurrence of a billing code for the procedure in the patient's records) that corresponds to implemented patient tracking technology in the system. As one example, the procedure may be flagged as a procedure that involves time-based billing by one or more caregivers. Upon recognizing such a procedure, the billing servers 204 may submit a request to patient tracking server 208, where the request includes an identity of the relevant patient, an identity of the relevant caregiver, and an approximate time for the procedure. Using the received information, the patient tracking server 208 may query the location server 206, as shown by Arrow B, to obtain data for all stored triggering events around the identified time, for the relevant patient and the relevant caregiver. The location server 206 may return such information, and the patient tracking server 208 may filter the information to identify which of the triggering events are also billing-related events.

In the example discussed above, the billing-related events may relate to times at which a caregiver first sees a patient or a time when a patient leaves a pre-op area, and a time when the patient returns to a recovery room. According to an agreed-upon protocol, the patient tracking server 208 may return relevant information to the billing servers 204, such as starting and ending times for the particular caregiver for the relevant procedure, or a computation of the amount of time allowed for the caregiver with respect to the procedure (Arrow C). The billing servers 204 may then compute a billed amount using such information, or may compare the computed amount to a reported amount obtained by other mechanisms (e.g., based on time information written down by the caregiver). When comparing such amounts, the system 200 may generate an exception where there is not a close enough match, and may employ various mechanisms for resolving the exception, as discussed in more detail below.

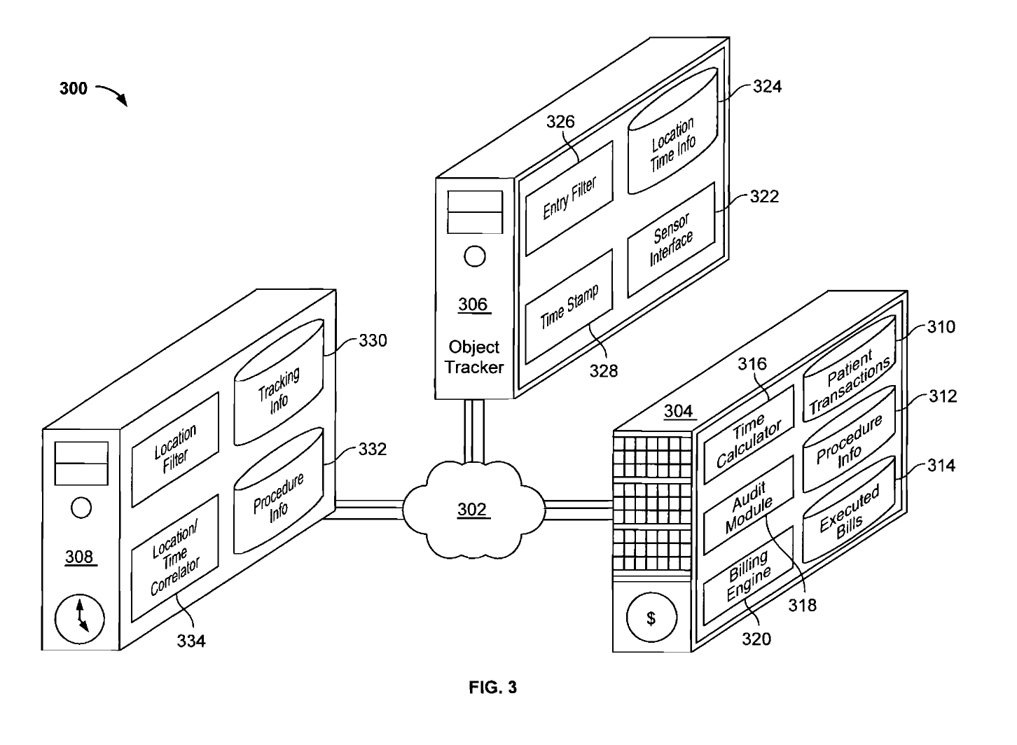

FIG. 3 is a schematic diagram showing computing structures in a healthcare billing system 300. In general, the system 300 is arranged for illustrative purposes similar to the system 200 in FIG. 2. However, particular arrangement of the components within the system, and the particular functions performed by such components may vary depending upon the particular implementation.

Here, the system 300 is shown as including a billing server 304 in the form of a rack or blade server, to indicate that such a server is typically relatively large and complex. The billing server 304 communicates through network 302 with an object tracker server 306 and a time/location server 308. Particular exemplary components are shown inside each of the servers 304, 306, 308.

Billing server 304 may include, for example, databases 310-314 relating to patients and the care and billing of patients. Patient transactions database 310 may track the various procedures performed on patients, and the various medications provided to patients. Such information may be used, for example, to generate bills relating to care for particular patients. Procedure information database 312 may include information relating to particular procedures performed on patients. For example, procedure information database 312 may include information relating to a fee schedule for particular procedures, the times when particular procedures were performed, the patients on which the procedures were performed, and the location or locations of the procedures. In this example, procedures may be broadly defined to include surgical procedures, dosing of medications, checking patient vital signs, and other such actions performed on or on behalf of a patient. Executed bills database 314 may include information for billing of patients, such as itemized billing information that may be provided by a patient or a payor associated with the patient.

Various modules within billing server 304 may access and analyze information such as the information stored in databases 310-314, may perform certain operations on such information, and may produce various reports or other output related to the information. Time calculator 316 may receive information relating to various procedure-related times, such as times at which a patient arrives in certain areas of a facility, or when a caregiver arrives in certain areas of the facility. Audit module 318 may contain code for operating a workflow to resolve exceptions found in data in system 300. For example, audit module 318 may provide for the review of information relating to patient billing in the comparison of different forms of data than they may provide input for patient billing. In particular, if time-location billing information does not match billing information entered by caregivers, the audit module 318 may manage a workflow for determining which entry method is likely the accurate method. The billing engine 320 may provide for traditional core healthcare billing functions, such as managing other modules to identify procedures performed on patients and other services provided to patients, and generating bills and follow-up materials related to such activity.

Object tracker 306 includes various components for receiving information about object locations (e.g., patient, caregiver, and equipment locations) in the facility, formatting such information, and storing the information for retrieval by various other services within system 300. Sensor interface 322 receives data from remote sensors, and may also provide information for controlling remote sensors. For example, sensor interface 322 may be communicatively connected to one or more wireless transceivers for receiving indications from sensors when transponders in a system pass the censors. Timestamp 328 may be provided to associate a time with the triggering events sensed by sensor interface 322. For example, a triggering event may be provided with a unique identification number, and may be stored with an identifier for the transponder that was sensed, an identifier for the sensor (or a location of such a sensor, or other such information), and a time indicating when the information was provided to the object tracker server 306, as determined by timestamp 328.

Location/time information database 324 may store such location-time information (e.g., pairs of location data and triggering time data, along with other data such as object ID data), along with other information needed for the operation of object tracker server 306. Entry filter 326 may perform logical operations on data for triggering events before or after the data is stored in location/time information database 324. With respect to filtering before storage of triggering event information, entry filter 326 may be provided with rules to determine which triggering events generate data that may need to be accessed later, and which do not. For example, triggering events associated with patients, where the events do not correlate to the patient's room or to any other location associated with patient billing or other such tracked information, may be filtered by entry filter 326, and not stored in location/time information database 324. Various other examples also exist regarding triggering events that may not require long-term storage.

Entry filter 326 may also filter information after it is stored, such as when a request for information is made by another server in system 300. For example, another server may request information relating to a particular procedure performed on a particular patient. Entry filter 326 may serve to query location/time information database 324 to obtain such information. In addition, entry filter 326 may limit the amount of responsive information that is returned to such a request. As one example, location/time information database 324 may store a number of triggering events relating to a patient in a particular procedure, but only a limited number of such events may be relevant to a query made by another server. In such a situation, rules associated with entry filter 326 may review the request, determine which information of the located information is necessary to fulfill the request, and may filter out unnecessary information from any response.

Location/time server 308 may be provided to access information stored by object tracker database 306, process such information, and provide input to billing server 304 to assist in a patient billing process. Location/time server 308 may include a location filter 336 that may provide for further filtering of object tracking information received from object tracker server 306. For example, where entry filter 326 is not present, or where it only partially filters results, location filter 336 may provide additional filtering as directed by a query associated with location/time server 308. As indicated above, such various forms of filtering may be directed to lessening computing load on a system, to help identifying appropriate time information, and/or to improving patient privacy.

A location/time correlator 334 may be provided to perform certain operations on information received from object tracker server 306 relating to locations of patients or caregivers, and times at which the patients or caregivers were sensed as being in the particular locations. As one example, the location/time correlator 334 may fetch a pair of time entries from location filter 336 (e.g., an entering and exiting time for an operating room), by identifying an object and a location for the object, may filter out irrelevant entries where there are too many entries, and may perform an operation such as a comparison and subtraction on returned values to generate, for example, an elapsed time for a patient in a particular area of the facility. As with other modules discussed with respect to system 300, location/time correlator 334 may also be provided in a different server or in a different manner in system 300.

The components of location/time server 308 may access information stored locally, either temporarily or on a long-term basis, from databases on server 308, or may access remotely stored information. For example, procedure information (which may be obtained from billing server 304) may be stored in procedure information database 332, so that location/time server 308 may readily associate patients, locations, and caregivers with each other when queried for information by billing database 304.

Tracking information database 330 stores certain information obtained from object tracker server 306, or that is derived from such information. For example, location/time server 308 may periodically or continuously receive information about objects in a facility from object tracker server 306, and may retain only a subset of all such information that is relevant to its operations. For example, location/time server 308 may be concerned with the locations of patients and caregivers at certain points in time, but may be unconcerned about the location for other triggering events, and may also be unconcerned with the location of medical equipment (which may be tracked separately by an equipment inventory application).

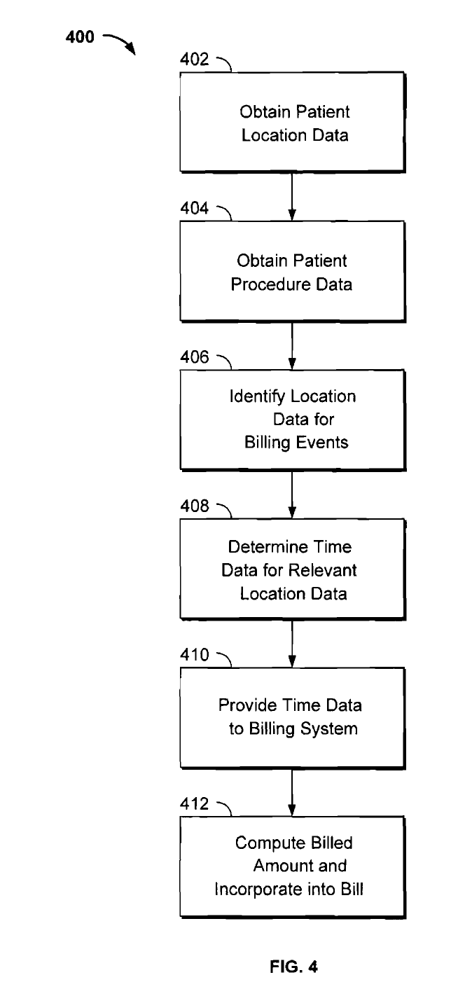

FIG. 4 is a flow chart showing actions associating patient activity with billing activity. In general, a process 400 is shown by which location data for patients and other objects in a healthcare facility may be tracked, and may be used to create or verify certain billing-related events. At box 402, patient location data is obtained for a healthcare facility. Such collection of data may occur continuously, as location sensors are triggered by the passing of various objects in the facility that been provided with transponders, such as RFID tags. The location data may be stored in various formats, including with time data associated with the times when certain locations were observed for the objects, and also with identification data for the particular objects. The storage of time information may take the form, for example of Coordinated Universal Time (UTC). Storage of time data in a manner that does not depend on a particular time zone may be used, in particular, for an organization having facilities spread across multiple time zones.

At box 404, patient procedure data is obtained. The triggering event for obtaining such data may be the performance of a billing cycle, whereby a healthcare billing system seeks to obtain certain information for determining an amount to bill a patient. Such a system may send requests for information on procedures performed on the patient so that additional information regarding the procedures may be obtained before a billing action is carried out. For example, a database may be searched for all billing codes that have been entered during a particular period for that patient.

At box 406, location data for particular billing events is identified. For example, a procedure identifier may be provided by a billing system, and that identifier may be used to identify rooms associated with the procedure, and caregivers associated with the procedure. The locations of the patient and the caregivers at particular times around an identified time for the procedure may then be retrieved, and may be filtered to identify location data that may be relevant for billing.

The system may then, at box 408, determine time data for relevant location data. For example, if arrival at a patient room by a caregiver is determined to be relevant location data and is filtered from a larger data set, the system may then perform a lookup to identify a time at which the caregiver arrived at the patient's room. In certain implementations, different times may be compared so as, for example, to compute an elapsed time, such as when the elapsed time may be multiplied by a billing rate to produced a billed amount.

With timing information determined, such information may be provided back to a more general billing system, as shown in box 410. The information returned may depend, for example, on the form of request from the billing system, and may be formatted according to an agreed-upon protocol. For example, the billing system may be provided with an identification number for a procedure, along with times that may be relevant to the procedure.

The billing system may then use the received times to compute a billed amount and incorporate that amount into a bill for the patient, as shown at box 412. For example, the billing system may compute an elapsed time for a billing event, using times received from another system, or, for example, a mixture of times entered by a caregiver and times measured by the system. As one example, a start time may be obtained from a medical record system, according to a time at which a particular entry was made on a patient's medical chart. An end time, in contrast, may be obtained from a patient location tracking system, such as the time that the patient left an operating room, or entered a recovery room.

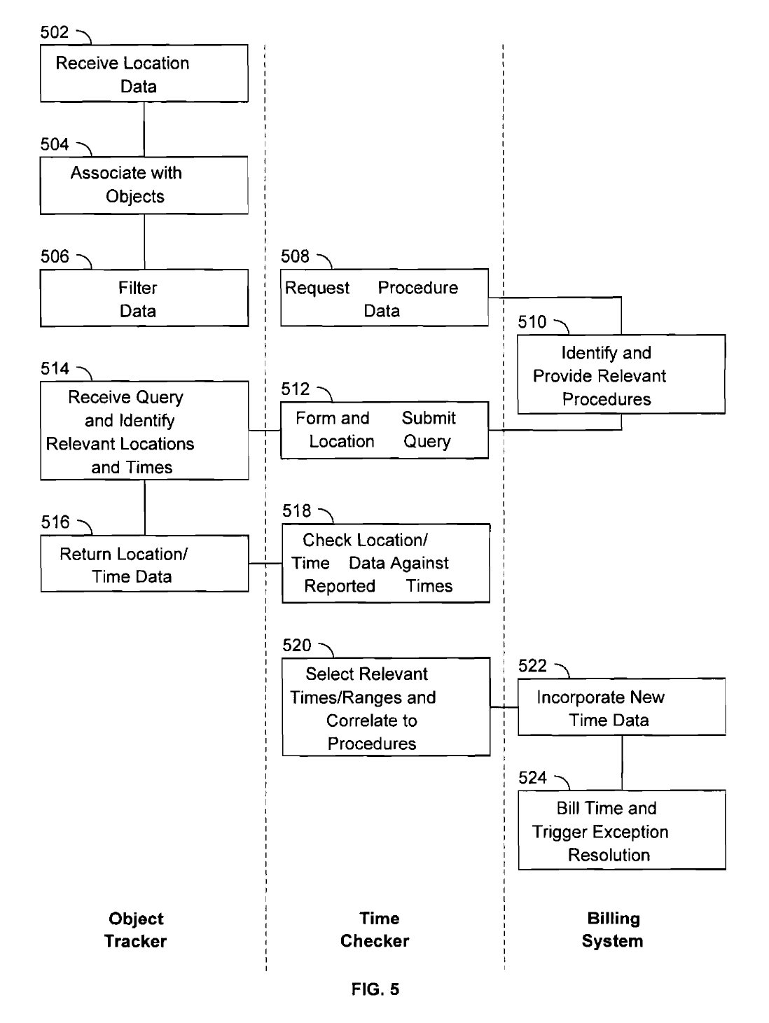

FIG. 5 is a swim lane diagram showing actions for coordinating patient tracking with billing. In general, the actions here may be similar, in certain implementations, to the actions shown in FIG. 4. the actions shown here are organized, however, for illustrative purposes, according to portions of a system in which they are performed. Those portions of the system are (a) an object tracker, which may function to receive indications of the locations of objects as they move through a healthcare facility; (b) a time checker which determines times or elapsed times of certain events in the system using information from the object tracker; and (c) a billing system, which may perform a variety of billing, patient management, and hospital management functions.

At box 502, location data is received by the object tracker, such as via wireless receivers that communicate with a central server. The received information may include ID numbers for particular RFID tags or other such transponders that are being interrogated. At box 504, particular objects are associated with the received data. For example, a table may include fields for RFID tag numbers and fields identifying particular objects (e.g., a patient wearing the particular tag on their wrist). The objects may include, for example, patients, caregivers, or movable equipment in a healthcare facility.

At box 506, the received data is filtered. For example, where the system serves multiple different functions, data for each of those functions may be broken out from other such data. As one example, tracking of patients may be separated from tracking of caregivers, which may in turn be separated from tracking of physical inventory such as equipment or medications. In general, the receipt of data associated with objects, and the filtering of the data, may be performed continuously as various objects are tracked as they move around a healthcare facility.

At some point in time, a time checker may request procedure data (box 508) from a billing system, or alternatively, a billing system may trigger itself to obtain such data. At box 510, the billing system identifies and provides relevant patient procedures associated with the request. For example, a request may seek all procedures associated with a particular patient and for a particular caregiver, and the billing system may return information regarding procedures for such a patient or caregiver. As one example, over a long hospital stay, one patient may have one or more operating room visits with attendant procedures performed on the patient, along with numerous physical therapy or occupational therapy sessions, before being released from the hospital. As shown in the pictured process, information about all such procedures, such as a location for the procedures, healthcare providers associated with the procedures, approximate time for the procedures, and other information, may be provided

Time checker may then use such received information to form and submit a location query (box 512) to the object tracker. For example, the time checker may submit a query to receive all triggering events for a particular patient and for caregivers associated with the patient during a window of time around a procedure performed on the patient. As one example, if the procedure is identified as a physical therapy procedure, the billing system may check with a scheduling system to determine that the patient had a physical therapy session in the morning on a certain day, and the time checker may submit a query to the object tracker that would include all times in which the patient passed a sensor near a physical therapy department in a time window that covered that particular day.

At box 514, an object tracker receives a query and identifies relevant locations and times. In the example above, the relevant locations may be at a sensor near a door to a physical therapy department, and the times may be two times approximately 1 hour apart, when the patient passed through the doors. The object tracker may then, as shown in box 516, return such location and time data to the time checker. If three times are received for the sensor, so that clear entering and leaving times for a patient cannot be determined easily, various disambiguation rules may be used to determine which triggering events should be used to compute an elapsed time. At box 518, the time checker checks location-time data against reported times. In this example, the system is being used as a check on other reported times to ensure that those times were entered accurately and no errors were made. Thus, the time checker would access reported times, for example, entered by a physical therapist or anesthesiologist, for a procedure, as obtained from the billing system, and compare those times to the times measured by the system. Such a comparison, if an exception is generated, may be an indication that there was an error in recording time, and that certain follow up steps may be needed.

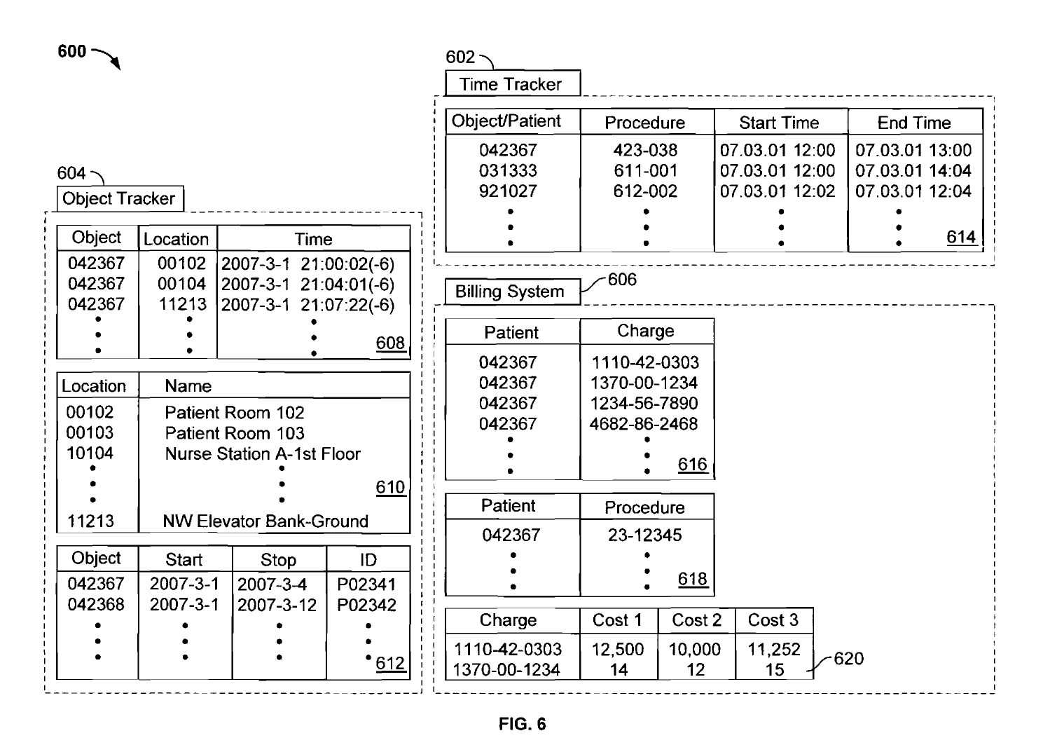

FIG. 6 is a conceptual diagram showing example database elements for a healthcare billing system. In general, the elements 600 provide one example of a manner in which various records and fields may be organized in such a system. The example is provided for illustration only, and is not intended to limit the techniques, systems, or methods described here.

As shown, the elements are organized into three general systems: a time tracker 602, an object tracker 604, and a billing system 606. In this implementation, the time tracker may be shown to have a single table (614) that correlates particular objects, such as patients, to particular procedures, and also provides start and end times for those procedures. Other objects may also be tracked, such as caregivers, so that time spent by a particular caregiver with respect to a particular procedure may be determined.

Object tracker 604 stores information about various objects that have been sensed in a facility, and times and locations associated with such sensing of the objects. A first table (608) correlates objects to locations (or to sensor IDs, where the sensors are in known locations), and the times that the objects were sensed in the particular locations. In this example, values for a particular object, such as a patient, are shown. In the example, the patient passes a first location on March 1 at about 9 p.m. and passes a second location about four minutes later, and a third location about three minutes after that. Each of the times and locations are tracked and are associated with the object (e.g., patient) in the table (608).

In another table (610), location identifiers and location names are correlated with each other. While computers may generally use simply the location identifiers in making computations, users of a system may prefer more intuitive location names. As a result, table 610 may be accessed when preparing information for reports or for other review by managers or others.

Table 612 provides active periods for particular objects, with respect to particular device IDs. Such tracking permits a single transponder to be used multiple times with different patients, and still maintain the capability to distinguish one patient from another in the system. For example, one patient may be associated with the transponder one week, while another patient can be associated the next week. Without tracking timing of patients in this manner, actions with respect to a particular transponder may not be able to be associated with any of several patients who used the transponder. In contrast, with tables 612, the identity of the patient may be determined by comparing the time or date on which a triggering event occurred with the device, to a time range during which the patient was staying at a particular facility.

Billing system 606 may include numerous tables for tracking patient activity, billing, and other operations of a healthcare system or healthcare facility. Three example tables are shown here. Table 616 lists patients and all charges associated with those patients. The charges may follow various standard formats for billing codes, and may represent all chargeable events for a patient during a stay with the system. Such information may be used to form a complete bill for a patient stay at a facility. Table 618 lists the patient and all procedures performed on the patient. Such a table may not be necessary, and could be subsumed in some situations within particular charge numbers for the procedures. However, in certain implementations, a charge number may represent a procedure in general (e.g., an appendectomy), while the procedure number can represent the particular procedure performed on the particular patient (i.e., John Doe's appendectomy performed Jan. 1, 2000). Tracking of the particular procedure may permit a system, for example, to store particular data about the procedure, such as the caregivers that were involved in the procedure and the room in which the procedure was performed. Such information may be used, as described above, to track timing information for the procedure for purposes such as bill creation or bill verification.

Table 620 is a simplified form of a charge table—showing various charges to be applied for various chargeable events. In the example, the first entry may be the cost for a particular surgical procedure, while the second may be the cost for administering a pain medication to a patient. Other costs may represent hourly rates to be billed by certain caregivers. Various costs are shown here, as healthcare organizations frequently negotiate different price structures with different payors. The information in table 620 may be used, for example, when determining amounts to be included on a bill, such as by cycling through every charge associated with a particular patient during a particular time period, and matching a cost to each charge.

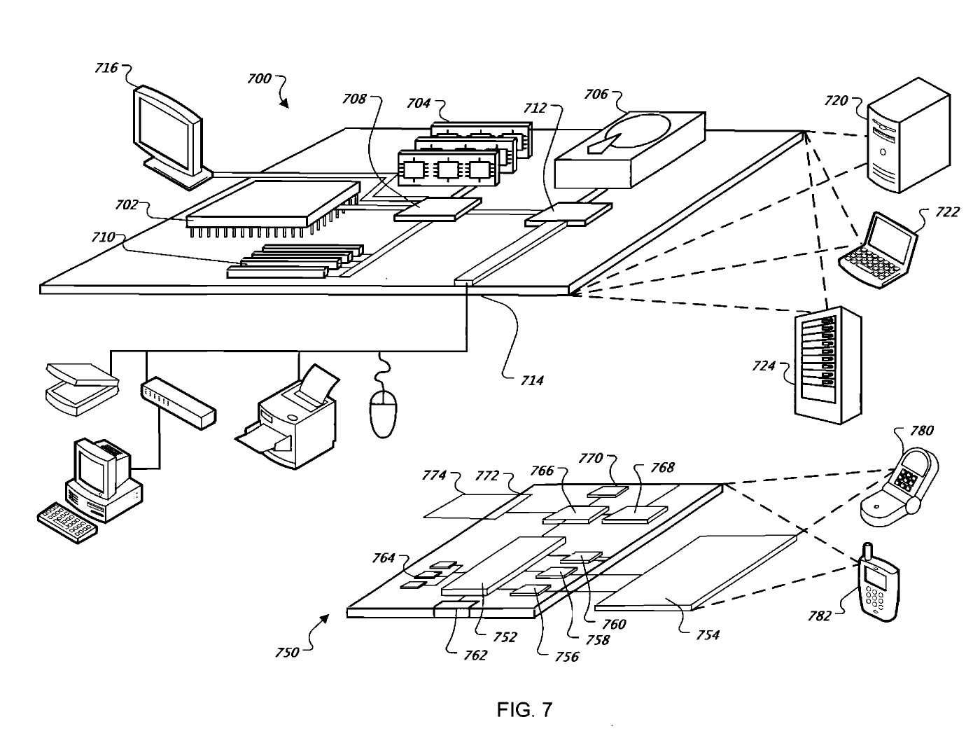

FIG. 7 is a block diagram of computing devices 700, 750 that can be used to implement the systems and methods described herein, as either a client or as a server or plurality of servers. Computing device 700 is intended to represent various forms of digital computers, such as laptops, desktops, workstations, personal digital assistants, servers, blade servers, mainframes, and other appropriate computers. Computing device 750 is intended to represent various forms of mobile devices, such as personal digital assistants, cellular telephones, smartphones, and other similar computing devices. The components shown here, their connections and relationships, and their functions, are meant to be exemplary only, and are not meant to limit implementations described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a computer-readable medium. In one implementation, the memory 704 is a volatile memory unit or units. In another implementation, the memory 704 is a non-volatile memory unit or units.

The storage device 706 is capable of providing mass storage for the computing device 700. In one implementation, the storage device 706 is a computer-readable medium. In various different implementations, the storage device 706 may be a floppy disk device, a hard disk device, an optical disk device, or a tape device, a flash memory or other similar solid-state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 704, the storage device 706, memory on processor 702, or a propagated signal.

The high-speed controller 708 manages bandwidth-intensive operations for the computing device 700, while the low speed controller 712 manages lower bandwidth-intensive operations. Such allocation of duties is exemplary only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can process instructions for execution within the computing device 750, including instructions stored in the memory 764. The processor may also include separate analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD display or an OLED display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provided in communication with processor 752, so as to enable near area communication of device 750 with other devices. External interface 762 may provide, for example, for wired communication (e.g., via a docking procedure) or for wireless communication (e.g., via Bluetooth or other such technologies).

The memory 764 stores information within the computing device 750. In one implementation, the memory 764 is a computer-readable medium. In one implementation, the memory 764 is a volatile memory unit or units. In another implementation, the memory 764 is a non-volatile memory unit or units. Expansion memory 774 may also be provided and connected to device 750 through expansion interface 772, which may include, for example, a SIMM card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provided as a security module for device 750, and may be programmed with instructions that permit secure use of device 750. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, memory on processor 752, or a propagated signal.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, WiFi, or other such transceiver (not shown). In addition, GPS receiver module 770 may provide additional wireless data to device 750, which may be used as appropriate by applications running on device 750.

Device 750 may also communicate audibly using audio codec 760, which may receive spoken information from a user and convert it to usable digital information. Audio codec 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smartphone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other categories of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Embodiments may be implemented, at least in part, in hardware or software or in any combination thereof. Hardware may include, for example, analog, digital or mixed-signal circuitry, including discrete components, integrated circuits (ICs), or application-specific ICs (ASICs). Embodiments may also be implemented, in whole or in part, in software or firmware, which may cooperate with hardware. Processors for executing instructions may retrieve instructions from a data storage medium, such as EPROM, EEPROM, NVRAM, ROM, RAM, a CD-ROM, a HDD, and the like. Computer program products may include storage media that contain program instructions for implementing embodiments described herein.

A number of implementations have been described. Nevertheless, it will be understood that various modifications may be made without departing from the spirit and scope of this disclosure. Accordingly, other implementations are within the scope of the claims.

What is claimed is:

1. A computer-implemented method, comprising:
relating a transponder with a healthcare patient;
identifying one or more locations of the patient using the transponder, and associating the one or more locations with one or more time values; and
associating the one or more locations or time values with one or more billable events in the patient's care.

2. The computer-implemented method of claim 1, wherein the transponder is mounted to a piece of medical equipment attached to the patient.

3. The computer-implemented method of claim 2, wherein the piece of medical equipment comprises an IV device.

4. The computer-implemented method of claim 1, wherein the transponder is attached to the patient.

5. The computer-implemented method of claim 1, wherein the transponder includes an RFID chip.

6. The computer-implemented method of claim 1, wherein the billable events include a stop time for anesthesia billing.

7. The computer-implemented method of claim 6, wherein the one or more locations include entry of a patient into a recovery room.

8. The computer-implemented method of claim 6, further comprising computing a billable amount using a time of exit from a pre-operative holding area.

9. The computer-implemented method of claim 6, wherein the billable events include a start time for a procedure performed on the patient.

10. The computer-implemented method of claim 1, wherein the billable events include arrival and departure from a room in a facility.

11. The computer-implemented method of claim 1, further comprising mediating challenges to billing amounts for the billable events.

12. The computer-implemented method of claim 1, further comprising computing an elapsed time using the one or more time values.

13. The computer-implemented method of claim 12, further comprising computing a fee based on the elapsed time.

14. The computer-implemented method of claim 1, further comprising associating the billable events with a hospital billing code.

15. The computer-implemented method of claim 1, further comprising obtaining the one or more locations from a facility scheduling program.

16. A computer-implemented system, comprising:
memory storing time-location information for a plurality of patients in a healthcare system, the time-location information correlating a physical location of a patient with a time the patient was at the physical location;
a time-location server to identify one or more billing events for a patient base on the time-location information; and
a billing server to generate a billing level for the patient based on the one or more identified billing events.

17. The system of claim 16, wherein the time-location server associates a location with stored procedure data on a procedure performed on the patient.

18. The system of claim 16, wherein the time-location server filters time-location information based on a time of a procedure performed on the patient.

19. The system of claim 16, wherein the billing server uses the one or more identified billing events to confirm accuracy of billing information entered by one or more caregivers.

20. The system of claim 16, wherein the billing level is associated with a billing code.

21. A computer-implemented system, comprising:
memory storing time-location information for a plurality of patients in a healthcare system, the time-location information correlating a physical location of a patient with a time the patient was at the physical location; and
means for associating locations of patients with procedures performed on the patients to generate time information for patient billing.
